(19) United States
(12) Patent Application Publication
(10) Pub. No.: US 2007/0003361 A1
(43) Pub. Date: Jan. 4, 2007

(54) Locking device for a telescopic tube

(76) Inventor: Shu-Mei Wang, Dajia Township (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/173,104

(22) Filed: Jul. 1, 2005

(51) Int. Cl. F16B 7/10

(52) U.S. Cl. 403/109.3

(57) ABSTRACT

A locking device for a telescopic tube includes a knob, a connecting rod partially received in the knob and an actuated rod partially and movably received in the connecting rod and connected to the knob. The knob is used to longitudinally drive the actuated rod when adjusting the total length of the telescopic tube.

### BACKGROUND OF THE INVENTION

1. Field of the Invention

The present invention relates to a locking device, and more particularly to a locking device for a telescopic tube.

2. Description of Related Art

A conventional locking device for a telescopic tube in accordance with the prior art shown in FIGS. 6-8 comprises a knob (50) having a round hole (51) centrally defined therein for longitudinally receiving a connecting section (61) of a connecting rod (60). The connecting rod (60) is formed with threaded section (62) opposite to the connecting section (61) thereof. The threaded section (62) is screwed into a skirt (42) that perpendicularly extends from an outer periphery of an outer tube (40) of the telescopic tube (40). The connecting rod (60) has a through hole (63) longitudinally defined therein. A shoulder (not numbered) is formed on an inner periphery of the through hole (63) and corresponds to the connection section (61). An actuated rod (70) is partially and reciprocally movably received in the through hole (63), and a bolt (52) extends through the knob (50) and is screwed into the actuated rod (70) for connecting the knob (50) and the actuated rod (70). An annular protrusion (71) is laterally extending from the actuated rod (70) and selectively abuts the outer periphery of the outer tube (40) to prevent the actuated rod (70) from overly extending into the outer tube (40). A spring (73) is compressively sleeved on the actuated rod (70). The spring (73) has two opposite ends respectively abut against the annular protrusion (71) and the shoulder on the inner periphery of the through hole (63). The actuated rod (70) extends through the outer tube (40) and an inner tube (41), which is selectively positioned in the outer tube (40), to decide the total length of the telescopic tube. The inner tube (41) can be moved relative to the outer tube (40) to adjust the total length of the telescopic tube when the user pull the knob (50) and the actuated rod (70) is disengaged from the inner tube (41). The actuated rod (70) extends through the inner tube (41) again to locking the inner tube (41) with the outer tube (40) due to the restitution force of the spring (73) when telescopic tube extends to a suitable length.

The user needs to pull the knob (50) with one hand to make the actuated rod (70) be disengaged from the inner tube (41) and pull/push the inner tube (41) to adjust the total length of the telescopic tube. However, it is difficult to only use one hand to control the inner tube (41) when a heavy object is hung on the inner tube (41). As a result, the inner tube (41) may be suddenly and quickly moved relative to the outer tube (40). It is very dangerous.

The present invention has arisen to mitigate and/or obviate the disadvantages of the conventional locking device for a telescopic tube.

### SUMMARY OF THE INVENTION

The main objective of the present invention is to provide an improved locking device for a telescopic tube, which can be temporarily positioned to make the user adjust the telescopic tube under a safe condition.

To achieve the objective, the locking device in accordance with the present invention comprises includes a knob, a connecting rod partially received in the knob and an actuated rod partially and movably received in the connecting rod and connected to the knob. The knob is used to longitudinally drive the actuated rod when adjusting the total length of the telescopic tube. The knob has a non-round hole centrally and longitudinally defined therein. The connecting rod has a connecting section movably received in the non-round hole. The connecting section has a cross-section corresponding to that of the non-round hole such that the knob and the actuated rod can not automatically back to the original position because the bottom of the knob engaged to the distal edge of the connecting rod such that the user can use two hands to pull/push the inner tube of the telescopic tube to adjust the total length of the telescopic tube under a safe condition.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a locking device for a telescopic tube in accordance with the present invention;

FIG. 2 is an exploded perspective view of the locking device in FIG. 1;

FIG. 3 is a schematic cross-sectional view of the locking device in FIG. 1;

FIG. 4 is a first operational view of the locking device in FIG. 3;

FIG. 5 is a second operational view of the locking device in FIG. 3;

FIG. 6 is an exploded perspective view of a conventional locking device for a telescopic tube in accordance with the prior art;

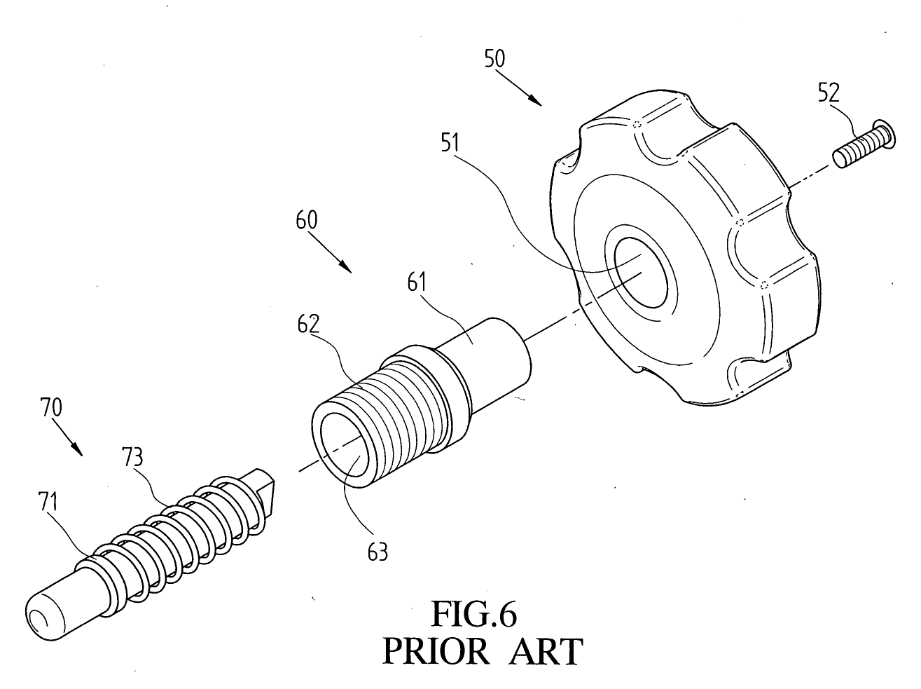

FIG. 7 is a schematic cross-sectional view of a conventional locking device for a telescopic tube in accordance with the prior art; and

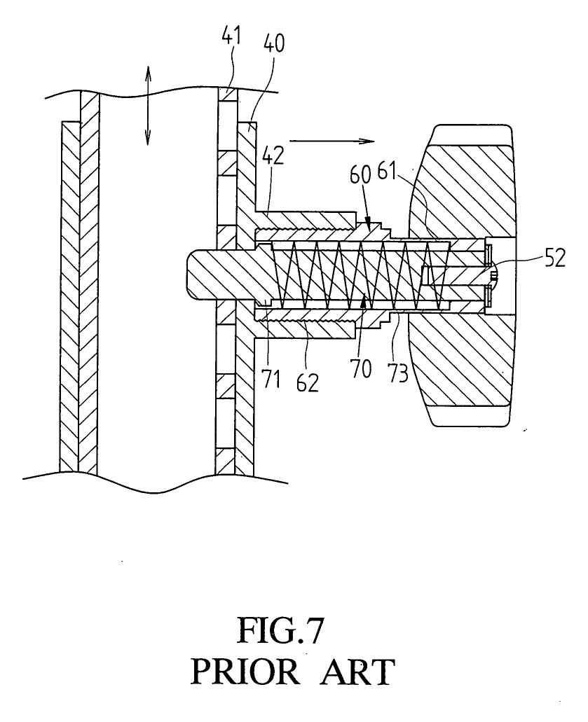

FIG. 8 is an operational view of the conventional locking device in FIG. 7.

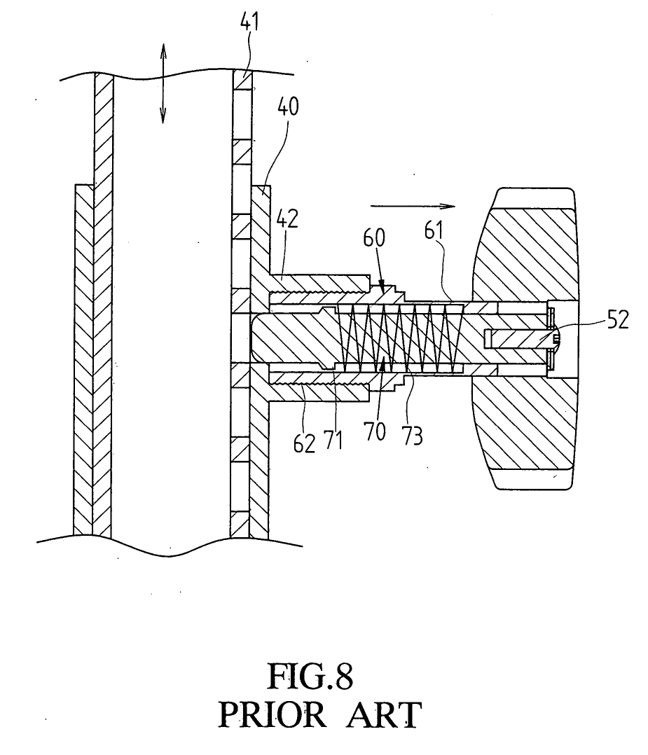

### DETAILED DESCRIPTION OF THE INVENTION

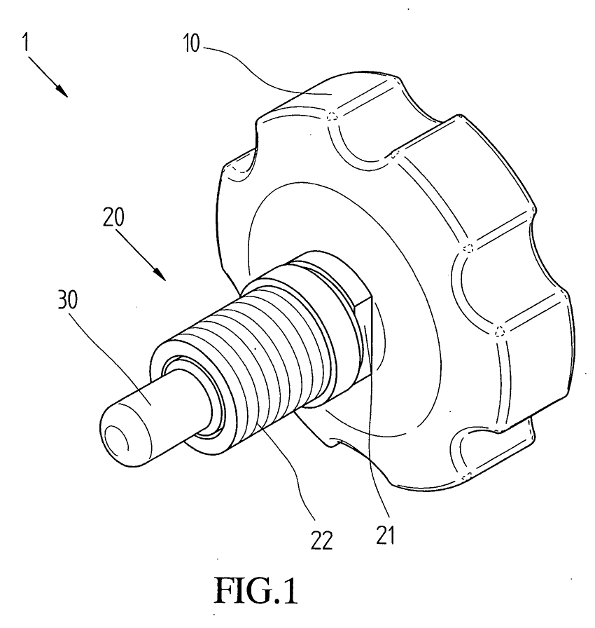

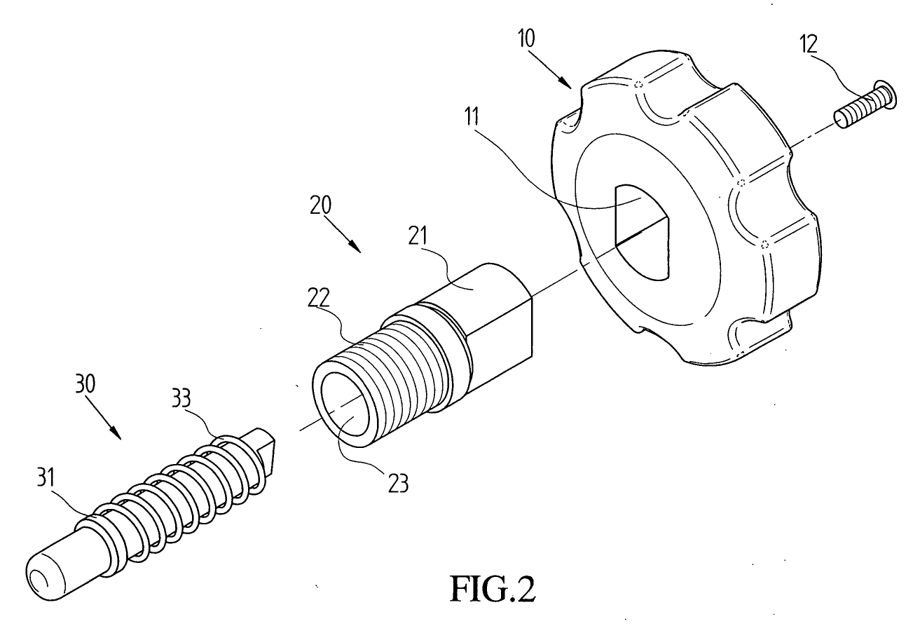

Referring to the drawings and initially to FIGS. 1-3, a locking device (1) for a telescopic tube in accordance with the present invention comprises knob (10), a connecting rod (20) partially received in the knob (10) and an actuated rod (30) partially and movably received in the connecting rod (20) and connected to the knob (10).

The knob (10) includes a non-round hole (11) centrally and longitudinally defined therein and a bolt (12) longitudinally extending into the non-round hole (11).

The connecting rod (20) has a connecting Section (21) movably received in the non-round hole (11) and a threaded section (22) formed opposite to the connecting section (21). The connecting section (21) has a cross-section corresponding to that of the non-round hole (11). A through hole (23) is longitudinally defined in the connecting rod (20), and a shoulder (24) inward extending from an inner periphery of the through hole (23) and corresponding to a distal end of the connecting section (21) of the actuated rod (20).

The actuated rod (30) is partially and reciprocally movably received in the through hole (23) and the bolt (22) is longitudinally screwed into a threaded hole (32) that is defined in one end of the actuated rod (30) for connecting the knob (10) and the actuated rod (30). An annular protrusion (31) is laterally extending from the actuated rod (70) and selectively abuts an outer periphery of an outer tube (40) of the telescopic tube to prevent the actuated rod (30) from overly extending into the outer tube (40). A spring (33) is compressively sleeved on the actuated rod (30). The spring (33) has two opposite ends respectively abut against the annular protrusion (31) and the shoulder (24) on the inner periphery of the through hole (23).

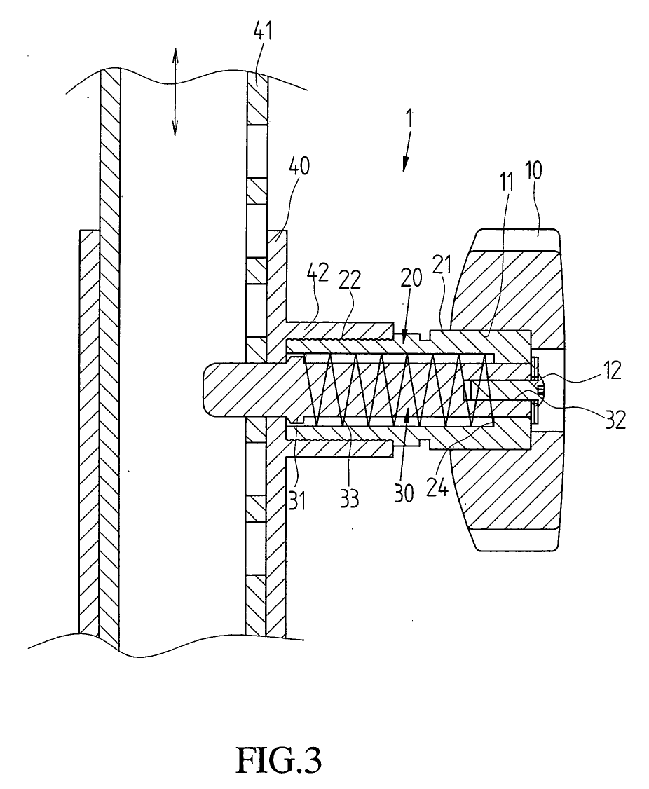

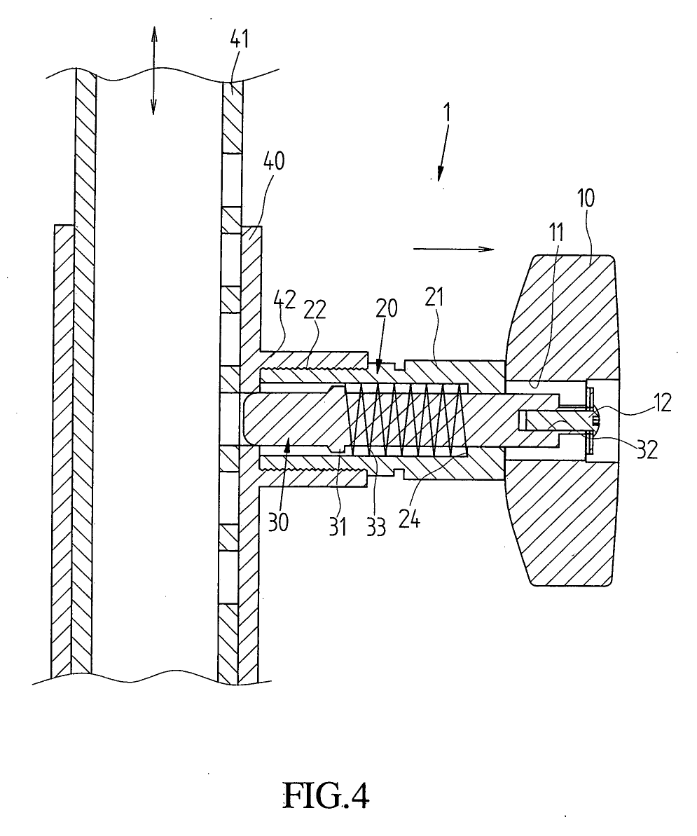

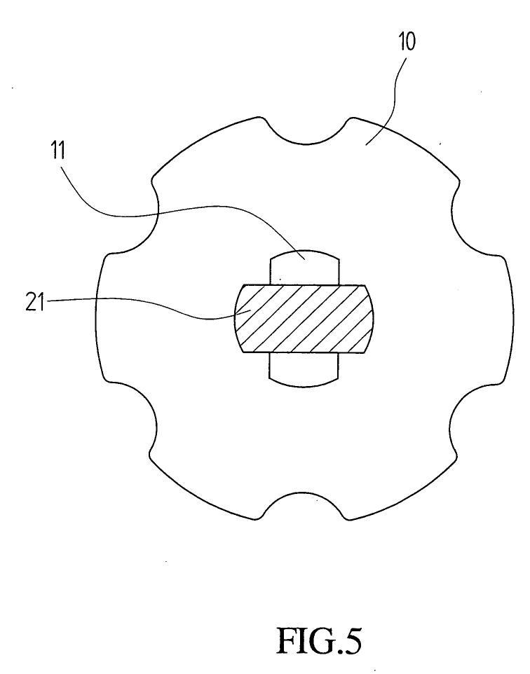

With reference to FIGS. 3-5, the threaded section (22) is adapted to be screwed into a skirt (42), which perpendicularly extends from an outer of the outer tube (40), to hold the locking device (1) of the present invention in place, and the actuated rod (30) extending through the outer tube (40) and the inner tube (41), which selectively movably received in the outer tube (40), to position the inner tube (41) relative to the outer tube (40). When adjusting the total length of the telescopic tube, the user pulls the knob (10) with the actuated rod (30), such that the knob (10) and the actuated rod (30) are moved relative to the connecting rod (20), to make the actuated rod (30) disengaged from the inner tube (41). The knob (10) is rotated to make the non-round hole (11) do not correspond to the connecting section (21). As a result, the knob (10) and the actuated rod (30) can not be moved to the original position due to the restitution force of the spring (33) because the bottom of the knob (10) engaged to the distal edge of the connecting rod (20) such that the user can use two hands to pull/push the inner tube (41) to adjust the total length of the telescopic tube under a safe condition. The knob (10) is rotated again to make the non-round hole (11) correspond to the connecting section (21) when the telescopic tube is adjusted to a suitable length and the knob (10) with the actuated rod (30) are moved to the original position thereof to lock the adjusted inner tube (41) due to the restitution force of the spring (33).

As described above, the hole (11) in the knob (10) is non-round such that the knob (10) and the actuated rod (30) can not automatically back to the original position when the non-round hole (11) does not correspond to the connecting section (21) of the connecting rod (20). As a result, the inner tube (41) does not be suddenly and quickly moved relative to the outer tube (40) because the user can use two hands to pull/push the inner tube (41) to adjust the total length of the telescopic tube under a safe condition when the bottom of the knob (10) engaged to the distal edge of the connecting section (21) of the connecting rod (20) due to the restitution force of the spring (33).

Although the invention has been explained in relation to its preferred embodiment, it is to be understood that many other possible modifications and variations can be made without departing from the spirit and scope of the invention as hereinafter claimed.

What is claimed is:

1. A locking device for a telescopic tube, comprising:
a knob including a non-round hole centrally and longitudinally defined therein;
a connecting rod partially and movably received in the non-round hole in the knob and adapted to be secured on an outer of the telescopic tube, the connecting rod having a connecting section movably received in the non-round hole, the connecting section having a cross-section corresponding to that of the non-round hole, a through hole longitudinally defined in the connecting rod, and a shoulder inward extending from an inner periphery of the through hole and corresponding to a distal end of the connecting section of the actuated rod; and
an actuated rod partially and reciprocally movably received in the through hole in the connecting rod, and connected to the knob, the actuated rod including an annular protrusion laterally extending from the actuated rod and selectively abuts an outer periphery of the outer tube of the telescopic tube to prevent the actuated rod from overly extending into the outer tube, and a spring compressively sleeved on the actuated rod, the spring having two opposite ends respectively abut against the annular protrusion and the shoulder on the inner periphery of the through hole.

2. The locking device as claimed in claim 1, wherein the actuated has a threaded hole defined in one end thereof and a bolt longitudinally extends through the knob and screwed into the threaded hole to connect the knob and the actuated rod.

3. The locking device as claimed in claim 1, wherein the connecting rod has a threaded section formed thereon opposite to the connecting section, the threaded section adapted to be screwed into a skirt, which perpendicularly extending from the outer periphery of the outer tube, to hold the locking device in place.

4. The locking device as claimed in claim 2, wherein the connecting rod has a threaded section formed thereon opposite to the connecting section, the threaded section adapted to be screwed into a skirt, which perpendicularly extending from the outer periphery of the outer tube, to hold the locking device in place.
